(19) United States
(12) Patent Application Publication
(10) Pub. No.: US 2010/0024622 A1
(43) Pub. Date: Feb. 4, 2010

(54) MAGNETIC COVER

(76) Inventor: Jong Hoon Kim, Seoul (KR)

Correspondence Address: KANG INTELLECTUAL PROPERTY LAW, LLC, 214 ELM STREET, SUITE 106, WASHINGTON, MO, 63090, US

(21) Appl. No.: 12/365,613

(22) Filed: Feb. 4, 2009

(30) Foreign Application Priority Data
Aug. 4, 2008 (KR) 10-2008-0076126

(51) Int. Cl. G10D 3/00

(52) U.S. Cl. 84/291

(57) ABSTRACT

The present invention relates to a magnetic cover that is coupled to a body of a product by means of a magnetic force, wherein the magnetic cover does not have any screw hole thereon since no screws are required to couple the magnetic cover to the body of the product, thereby providing good outer appearance to the product and conducting easy and convenient coupling and removing operations. In addition, even when the coupling and removing are carried out repeatedly or carelessly, no damage or deformation occurs, and further, no tool like a driver is needed for the coupling or removing.

### CROSS-REFERENCE TO RELATED APPLICATIONS

This application claims priority to Korean Patent Application No. 10-2008-0076126, filed on Aug. 4, 2008.

### BACKGROUND OF THE INVENTION

1. Field of the Invention

She present invention relates to a cover using a magnet, and more particularly, to a magnetic cover that is coupled to a body of a product through a magnetic force generated therefrom, without having to use screws.

2. Background of the Related Art

Musical instruments like guitars, furniture, domestic products, machines, tools and so on may have openings formed therein exposed to the outside. If left opened, dust or other foreign materials can enter the openings and damage parts mounted therein. In order to solve the above-mentioned problems, therefore, it is desirable to cover the openings, thereby preventing them from being left opened.

In known methods, the opening formed exposed to the outside on a body of a product has been covered with a cover, wherein a plurality of screw holes are formed on the cover such that the cover is coupled to the body of the product by inserting screws into the screw holes formed on the cover. However, the coupling between the cover and the body of the product through the screws gives no good outer appearance to the product, and further, if the fastening and removal of the screws to and from the body are repeatedly carried out or if the fastening and removing operations are carried out carelessly, the ‘−’ or ‘+’-shaped groove formed on the head portion of each screw can be deformed, thereby making it impossible to fasten and remove the screws to and from the body.

### SUMMARY OF THE INVENTION

Accordingly, the present invention has been made in view of the above-mentioned problems occurring in the prior art, and it is an object of the present invention to provide a magnetic cover that is coupled to a body of a product, without having to use screws.

To accomplish the above object, according to the present invention, there is provided a magnetic cover including a cover body; and a magnet member mounted into a mount hole formed in the cover body such that the magnetic cover is coupled to a body of a product through a magnetic force generated therefrom.

According to the present invention, furthermore, the magnetic cover has a clamp jaw formed extending outwardly at one side end thereof so as to help the magnetic cover be reliably coupled to the body of the product.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a guitar from which guitar strings are omitted;

FIG. 2 is a sectional view showing a neck of the guitar;

FIG. 3 is a perspective view showing a magnetic cover according to one embodiment of the present invention;

FIG. 4 is a side sectional view of FIG. 3;

FIG. 5 is a side sectional view showing the magnetic cover mounted on the head of the guitar according to one embodiment of the present invention; and

FIG. 6 is a side sectional view showing a magnetic cover mounted on the head of the guitar according to another embodiment of the present invention.

### DETAILED DESCRIPTION OF THE PREFERRED EMBODIMENT

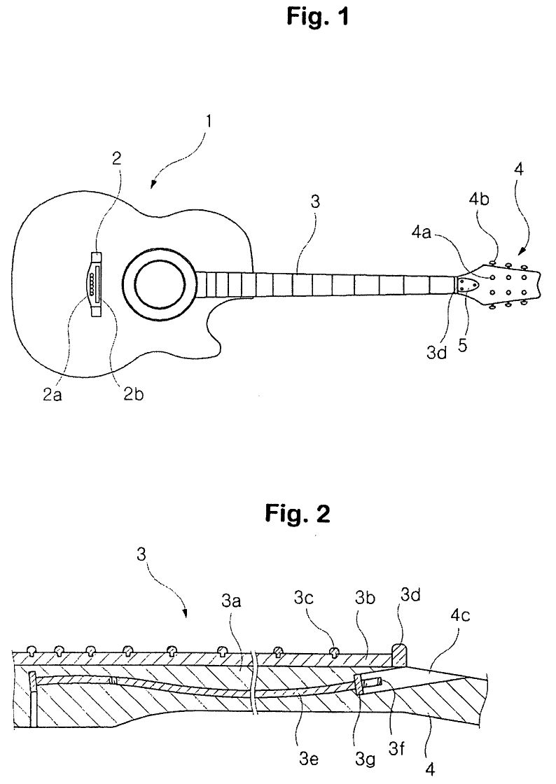

Hereinafter, the magnetic cover according to the present invention for use with, for example, the opening formed on a head of a guitar, will be in detail described with reference to the attached drawings. FIG. 1 is a perspective view showing the guitar with guitar strings omitted, and FIG. 2 is a sectional view showing a neck 3 of the guitar.

Generally, the guitar includes: a resonance body 1; a neck 3 extended to a predetermined length from the resonance body 1 in such a manner as to be fixed to the resonance body 1; a head 4 coupled to the end portion of the neck 3, and guitar strings (not shown). Generally, the resonance body 1 has a bridge 2 mounted on the top surface thereof, and the bridge 2 includes bridge pins 2a and a saddle 2b. Further, the head 4 is provided with a head machine, which is a combination of shafts 4a and string-tension adjusting tools 4b. In FIG. 1, a reference numeral 5′ denotes a cover as will be described below, wherein screws are insertedly mounted on the top portion of the cover 5′ so as to attach the cover 5′ to the head 4.

The neck 3 includes: a neck body 3a having a desired thickness; a finger board 3b attached on top of the neck body 3a; frets 3c installed on top of the finger board 3b at predetermined intervals; and a nut 3d installed at the end portion of the finger board 3b toward the head 4 on which the guitar strings are to be rested.

Further, the neck body 3a has a rod installation hole for receiving an adjustable truss rod 3e therein. The rod installation hole is formed inside the neck body 3a along the lengthwise direction, with one side closed and the other side opened toward the outside. Also, the neck 3 includes an adjustable truss rod 3e installed into the rod installation hole of the neck body 3a in order to help prevent the neck 3 from bending or being distorted due to the tension of the guitar strings.

The rod installation hole and the adjustable truss rod 3e are not formed straight, but they are formed in a curved manner as shown in FIG. 2. Also, the adjustable truss rod 3e is fixed to one side of the neck body 3a at one end thereof and has a threaded portion 3f at the other end thereof. The threaded portion 3f is crew-coupled with a female screw 3g supported by a step portion in the installation hole. The threaded portion 3f of the truss rod 3e is located close to the opened end of the installation hole so as to be accessible from the outside through an opening 4c of the installation hole. As the female screw 3g is fastened or unfastened, a degree of tension of the truss rod 3e can be adjusted.

In the illustrated construction, the rod installation hole formed inside of the neck body 3a is opened toward the head 4, and the opening 4c is formed on the surface of the head 4. The formation of the opening 4c is not good from the viewpoint of the outer appearance thereof, and foreign materials may enter the hole through the opening 4c. As shown in FIG. 1, therefore, the cover 5′ is mounted on top of the opening 4c using screws. Screw holes are bored on the cover 5′, and as screws are inserted into the screw holes and into the head 4, the cover 5′ is coupled to the head 4.

However, the coupling between the cover 5′ and the head 4 through the screws may impair the outer appearance of the guitar, and further, if the fastening and removal of the screws to and from the body of the head 4 are repeated, or if the fastening and removing operations are carried out carelessly, the ‘−’ or ‘+’-shaped groove formed on the screw head may be deformed, thereby making it impossible to fasten and remove the screws to and from the body of the head 4.

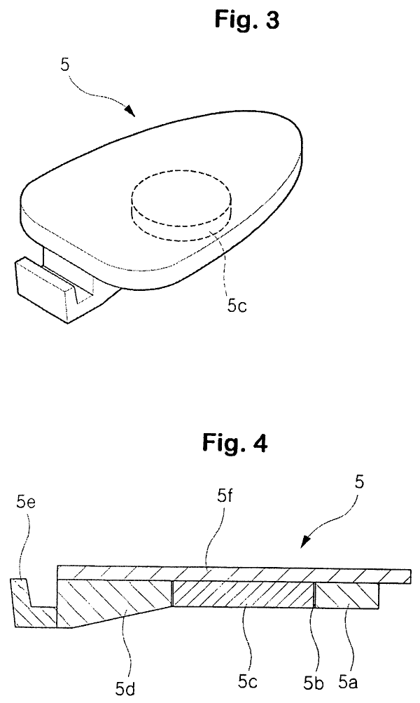

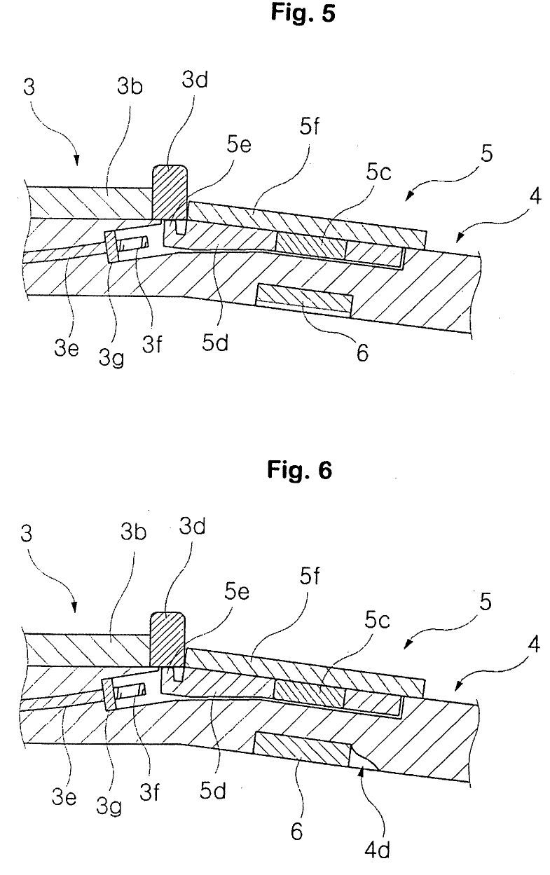

In order to solve the above-mentioned problems, thus, the magnetic cover 5 according to the present invention is provided with a magnet 5c therein. FIG. 3 is a perspective view showing a magnetic cover 5 according to one embodiment of the present invention, FIG. 4 is a side sectional view of FIG. 3, and FIG. 5 is a side sectional view showing the magnetic cover 5 mounted on the head 4 of the guitar according to one embodiment of the present invention.

According to the present invention, the magnet 5c can be installed in the magnetic cover 5 in a variety of ways. For example, as in the illustrated embodiment of the present invention, the magnetic cover 5 has a mount hole 5b the center portion of a cover body 5a and a magnet 5c mounted in the mount hole 5b. The mount hole 5b is of the same size with the magnet 5c or slightly smaller than the magnet 5c such that the magnet 5c can be press-fit to the mount hole 5b. The mount hole 5b can have the same depth as the thickness of the magnet 5c so that when mounted the bottom surface of the magnet 5c can be at the same level with the bottom surface of the cover body 5a. Alternatively, the mount hole 5b can have a depth larger than the thickness of the magnet 5c. In this alternative embodiment, after the magnet 5c is inserted to the mount hole 5b, a filler material can be filled within the mount hole 5b so as to cover the bottom surface of the magnet 5c. The filler material can be the same material as that of the cover body 5a. As another alternative, the magnet 5c can be made integral with the cover 5 at the same time when the cover 5 is manufactured by overmolding.

In the illustrated embodiment, the cover body 5a has a clamp jaw 5e extending out of one end thereof. Further, the cover body 5a has a downwardly protruding portion 5d formed on one side of the underside thereof so as to help the magnetic cover 5 be mounted well in the opening 4c. Preferably, the downwardly protruding portion 5d has a corresponding shape to the opening 4c of the head 4. The cover body 5a may have a plain top surface without any ornament. Alternatively, the cover body 5a can preferably have an ornament layer 5f having a desired shape and pattern on the top surface thereof.

As shown in FIG. 5, the head 4 can also have a magnet 6 mounted inside thereof. The magnet 6 can also be mounted in the head 4 in a variety of ways. For example, the head 4 has a mount hole of the same size with the magnet 6 or slightly larger than the magnet 5c such that the magnet 6 can be inserted in the mount hole. The mount hole can have the same depth as the thickness of the magnet 6 so that when mounted the bottom surface of the magnet 6 can be at the same level with the bottom surface of the head 4. Alternatively, the mount hole can have a depth larger than the thickness of the magnet 6. In this alternative embodiment, after the magnet 6 is inserted into the mount hole, an optional removable cover can be used to cover the bottom surface of the magnet 6. As another alternative, the magnet 6 can be made integral with the head 4 at the same time when the head 4 is manufactured by overmolding.

The magnet 6 mounted inside of the head 4 should be located in a corresponding position to the magnet 5c of the magnetic cover 5, and the magnet 5c and the magnet 6c should have different polarities facing to each other so as to attract each other.

When the magnetic cover 5 is placed on the head 4 into which the magnet 6 is mounted, the magnetic cover 5 is coupled to the surface of the head 4 through magnetic force generated between the magnet 5c and the magnet 6. Next, the magnetic cover 5 is pushed toward the neck 3, and as the clamp jaw 5e of the magnetic cover 5 comes into close contact with the underside of the nut 3d, the coupling between the magnetic cover 5 and the head 4 can be more secured.

When it is desired to remove the magnetic cover 5 from the head 4, the magnetic cover 5 is pushed to the opposite direction of the neck 3 so as to allow the clamp jaw 5e of the magnetic cover 5 to be released from the underside of the nut 3d of the neck 3. Next, with the application of a force enough to overcome the magnetic force, the magnetic cover 5 can be removed from the head 4.

In embodiments where the magnet 6 is not integral with the head 4, the magnet 6 can be removed for example by using a tool such as a driver. Then, the magnet 6 is replaced into the mount hole of the head 4 with the polarities of the magnet 6 changed such that the magnet 5c of the magnetic cover 5 and the magnet 6 of the head 4 now have the same polarities facing to each other. Accordingly, the pushing force between the magnet 5c and the magnet 6 is generated so as to help remove the magnetic cover 5 from the head 4. This allows the removal of the magnetic cover 5 from the head 4 to be easier.

FIG. 6 is a side sectional view showing a magnetic cover 5 mounted on the head 4 of the guitar according to another embodiment of the present invention. As shown in the illustrated embodiment, the magnet 6 is mounted in a mount hole in the underside of the head 4. The embodiment of FIG. 6 is the same with that of FIG. 5 except that an ejection groove 4d is formed at one side of the mount hole around the magnet 6.

In the embodiment as shown in FIG. 6, when it is desired to remove the magnetic cover 5 from the head 4, the magnetic cover 5 is pushed to the opposite direction of the neck 3 so as to allow the clamp jaw 5e of the magnetic cover 5 to be released from the underside of the nut 3d of the neck 3. Then, the magnet 6 is removed from the head 4 through the ejection groove 4d for example by using a tool such as drivers or by using a finger tip. Next, the magnet 6 is replaced into the mount hole of the head 4 with the polarities of the magnet 6 changed such that the magnet 5c of the magnetic cover 5 and the magnet 6 of the head 4 now have the same polarities facing to each other. Accordingly, the pushing force between the magnet 5c and the magnet 6 is generated so as to help remove the magnetic cover 5 from the head 4. This allows the removal of the magnetic cover 5 from the head 4 to be easier.

Although the magnetic cover 5 of the present invention is illustrated as applied to a guitar, it can also be applied to other products where a cover is needed. That is, the magnetic cover of the present invention can be applied to a variety of products such as furniture, domestic goods, machines, tools and the like. As no screw is needed, problems related to the use of screws, such as deformation of screw heads, can be avoided. A user need not worry about being hurt by the screw heads, or the user's clothing being damaged by the screw heads.

The clamp jaw 5e of the magnetic cover 5 serving to help more reliably couple the magnetic cover 5 with the head 4 may be omitted in the present invention, and if the body of the product on which the magnetic cover 5 is to be mounted is formed of a material like a steel which can be attracted by a magnetic force, there may be no need for the installation of the magnet 6 on the body of the product. In addition, although in the illustrated embodiment of the present invention the magnet 5c of the magnetic cover 5 is mounted at the center of the body of the magnetic cover 5, it may be mounted in other positions.

The body of the product on which the magnetic cover 5 is to be mounted is preferably carved so as to receive the volume of the magnetic cover 5 such that the surface of the magnetic cover 5 can have the same plane as the surface of the body of the product and that the magnetic cover 5 does not protrude upwardly from the body of the product.

Instead of the magnet 6 mounted inside of the body of the product, a steel piece may be mounted, and if an ejection groove 4d is formed on the surface of the body of the product adjacent to the magnetic cover 5, the magnetic cover 5 can be easily and conveniently removed from the body of the product by a user's finger.

As described in the foregoing, according to the present invention, the magnetic cover does not have any hole formed thereon since no screws are used to couple the magnetic cover to the body of the product, thereby providing good outer appearance to the product and conducting easy and convenient coupling and removing operations. In addition, even when the coupling and removing operations are carried out repeatedly or without any caution, no damage or deformation occurs, and further, no tool like a driver is needed upon the coupling or removing.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A magnetic cover comprising:
a cover body; and
a magnet mounted in the cover body
wherein the cover body has a clamp jaw extending outwardly from one end thereof,

2. The magnetic cover according to claim 1, wherein the magnet is integrally embedded in the cover body.

3. The magnetic cover according to claim 1, wherein the cover body has a mount hole, and wherein the magnet is installed in the mount hole.

4. (canceled)

5. The magnetic cover according to claim 1, wherein the cover body has a downwardly protruding portion formed on one side of a bottom surface of the cover body.

6. The magnetic cover according to claim 1, wherein the cover body has an ornament layer formed on the top surface thereof.

7. The magnetic cover according to claim 2, wherein the cover body has an ornament layer formed on the top surface thereof.

8. The magnetic cover according to claim 3, wherein the cover body has an ornament layer formed on the top surface thereof.

9. The magnetic cover according to claim 4, wherein the cover body has an ornament layer formed on the top surface thereof.

10. The magnetic cover according to claim 5, wherein the cover body has an ornament layer formed on the top surface thereof.
